(19) United States
(12) Patent Application Publication
(10) Pub. No.: US 2004/0136612 A1
(43) Pub. Date: Jul. 15, 2004

(54) Arrangement and method for low-interference recording of high-resolution two-dimensional images

(75) Inventors: Andreas Meister, Jena (DE); Joerg Standau, Jena (DE)

Correspondence Address: Gerald H. Kiel, Esq., REED SMITH LLP, 599 Lexington Avenue, New York, NY, 10022-7650, US

(73) Assignee: Smiths Heimann Biometrics GmbH

(21) Appl. No.: 10/741,878

(22) Filed: Dec. 19, 2003

(30) Foreign Application Priority Data
Dec. 20, 2002 (DE) 102 61 665.5

(51) Int. Cl. G06K 9/32

(52) U.S. Cl. 382/299

(57) ABSTRACT

The invention is directed to an arrangement for recording highly resolved two-dimensional images with a moving image sensor and to a method for generating optimized scan patterns for image recording systems which scan in two dimensions. The object of the invention is to find a novel possibility for recording high-resolution images with resolution-increasing two-dimensional sensor movement which achieves in a simple manner an appreciable reduction in image interference occurring when the object moves during the scanning movement of the image sensor. According to the invention, this object is met in that a scan pattern is provided for the sensor movement in a selected scan raster with n scan positions in x-direction and m scan positions in y-direction, which scan pattern has a fixed sequence of scan positions in the form of scan numbers, wherein there is a time interval of at least two scanning steps for spatially adjacent scan positions in x-direction and y-direction.

### CROSS-REFERENCE TO RELATED APPLICATION

This application claims priority of German Application No. 102 61 665.5, filed Dec. 20, 2002, the complete disclosure of which is hereby incorporated by reference.

### BACKGROUND OF THE INVENTION

a) Field of the Invention

The invention is directed to an arrangement for recording highly resolved two-dimensional images with a moving image sensor and to a method for generating optimized scan patterns for image recording systems which scan in two dimensions, particularly for recording fingerprints, handprints or footprints or other images to be evaluated geometrically in a highly precise manner in which movement cannot be excluded.

b) Description of the Related Art

Various recording methods can be used for high-resolution image acquisition of objects such as fingerprints and handprints. For example, it is possible to record an individual image of the entire object with highly resolving image sensors. However, sufficiently high-resolution image sensors with corresponding parameters are currently available only at a very high cost. In order to circumvent this, a highly resolved image can also be composed from a plurality of images with low resolution which are recorded successively and in a spatially offset manner. For this purpose, the image sensor is displaced between individual image recordings in order to record a plurality of images successively which are then assembled to form a resulting image.

It is possible to assemble the individual images in two ways:

1. Macroscan—Movement of the camera by a multiple of the sensor dimensioning, placement of whole individual images adjacent to one another (see FIG. 2a, example for 2×2 scan positions);

2. Microscan—Movement of the camera by a fraction of the sensor element (pixel) spacing, assembly of individual images by image points (interlacing) (see FIG. 2b, example for 2×2 scan positions).

The methods mentioned above are scanning (i.e., by means of sensor movement) recording methods, since the camera image sensor is displaced multiple times to record a complete image. The recording of highly resolved images with scanning recording methods is used especially in the acquisition of image objects that are at rest or moved only slightly.

The microscan method was developed in order to achieve a high optical image resolution of the resulting image with available low-resolution camera sensors (with low pixel density). The focus in the execution of the mechanical scanning movement of the microscan method is on minimizing the scanning paths of the camera and accordingly minimizing the scanning and image recording time. During image recording, the camera is moved in a meander-shaped manner beginning at position 1 (see FIG. 2c for an illustration of a 3×4 image scan).

Above all, the microscan method is used with small objects for which high resolution is required and takes into account the fact that commonly available image sensors (particularly CCD sensors) have between the light-sensitive image sensor elements areas which are not sensitive to light and which serve for the derivation of signals of the sensor elements. Because of the inhomogeneous sensitivity distribution within every sensor element, intermediate scanning by means of displacing the image sensor by fractions of its pixel raster already leads to an increase in resolution in every case and is therefore preferably used in scanners for fingerprints (so-called live scanners or fingerprint sensors) to record fingerprints, handprints and footprints with high optical resolution.

However, the behavior of the microscan method is disadvantageous when the object to be recorded, specifically a fingerprint or handprint, is moved during the recording. Depending on the type and speed of the movement, varying degrees of interference occur in the recorded image.

It can be seen that even a small (usually unconscious) movement during image recording results in pronounced formation of line-shaped artifacts. These effects are particularly pronounced in the direction in which the scanning steps for the most part immediately succeed one another in time, i.e., in the direction of the parallel meandering paths. The recorded images then convey the impression that the image recording hardware is not functioning properly or that digitization errors have occurred.

### OBJECT AND SUMMARY OF THE INVENTION

It is the primary object of the invention to find a novel possibility for recording high-resolution two-dimensional images with resolution-increasing two-dimensional sensor movement which achieves in a simple manner an appreciable reduction in image interference occurring when the object moves during the scanning movement of the image sensor.

In an arrangement for recording high-resolution two-dimensional images in which a scanning mechanism for two-dimensional movement of the image sensor is provided for a resolution-increasing multiplication of the scanned image points, the object is met, according to the invention, in that a scan pattern is provided for the sensor movement in a selected scan raster with n scan positions in x-direction and m scan positions in y-direction, which scan pattern has a fixed sequence of approached scan positions in the form of scan numbers, wherein there is a time interval of at least two scanning steps for spatially adjacent scan positions in x-direction and y-direction, which time interval is represented as the difference of scan numbers.

The scan pattern is advantageously optimized for a given scan raster (n×m) in such a way that the time intervals between respective spatially adjacent scan positions in the x-direction and y-direction in the entire scan pattern have a maximum and a minimum lying as close together as possible.

The scan pattern characterized above is preferably used for image recorders with an n×m microscan. However, it can also reasonably be used for a given n×m macroscan. The scan pattern designed in this way is advantageously integrated in the control software for the scan mechanism of the image sensor.

Further, in a method for generating an optimized scan pattern for two-dimensionally scanning image recording systems in which resolution is increased by movement of the image sensor in a determined scan raster and artifacts caused by the movement are suppressed, the above-stated object is met through the following steps:

Assignment of all possible scan patterns for the image sensor over all permutations of n×m scan positions for a given scan raster (n×m), wherein the time sequence of the scan positions is characterized by a scan number as a consecutive number of the scanning step;

Calculation of all differences of the scan numbers of adjacent scan positions for every scan pattern in x-direction and y-direction of the scan raster;

Determination of the minimum and maximum of all differences of scan numbers for the classification of every scan pattern;

Elimination of all scan patterns in which the minimum of the differences is equal to one;

Selection of the suitable scan pattern by means of a selection criterion in which the maximum and minimum of the differences of the scan numbers lie as close together as possible.

The selection of the suitable scan pattern is preferably carried out by comparing the differences of the maximum and minimum of every scan pattern; the scan pattern with the smallest difference from the maximum and minimum of the scan number differences represents an optimum.

Another advisable and stricter criterion for the selection of the suitable scan pattern results from comparison of the quotients from the minimum and maximum of every scan pattern in that the scan pattern with the greatest ratio of minimum to maximum of the scan number differences is selected as optimum.

The core of the invention is a reorganization of conventional microscan methods by dispensing with the meander-shaped step sequence of scan positions in the scan raster. The invention is based on the understanding that sensor movement in linearly elongated meandering paths promotes the formation of artifacts when slight movements of the object cannot be avoided. The invention solves this conflict between path-optimized and time-optimized scanning movement and the formation of artifacts by:

preventing direct succession in time of spatially adjacent scan positions during the scanning movement;

reducing the maximum time intervals of the individual positions in the scan raster;

preventing a preferred direction during the movement of the image sensor and, therefore, reducing the formation of line skips in the resulting image.

By means of the invention, it is possible to realize a recording of two-dimensional images with resolution-increasing two-dimensional sensor movement which achieves an appreciable reduction in image interference occurring as a result of slight movement of the object during the scanning movement of the image sensor in a simple manner. The method can easily be integrated for all available image recorders which move in a defined scan raster (2×2, 3×3, 3×4, 4×4, etc.) for increasing resolution. Only a software update and a (one-time) recalibration of the scanner with the new scan pattern are required for this purpose.

In the following, the invention will be explained more fully with reference to embodiment examples.

### BRIEF DESCRIPTION OF THE DRAWINGS

In the drawings:

FIG. 1 is a basic view of a scan pattern according to the invention based on a schematic time sequence of 12 scanning steps in a selected 3×4 scan raster;

FIG. 2a shows a schematic view of a 2×2 macroscan according to the prior art;

FIG. 2b shows a schematic view of a 2×2 microscan according to the prior art;

FIG. 2c shows a scan pattern for a 3×4 microscan with conventional meander scanning according to the prior art;

FIG. 3 shows a view of the time intervals between scan positions in the conventional meander scan pattern for a 3×4 microscan;

FIG. 4 is a view illustrating the equivalence of permutations with different start positions of the scan;

FIG. 5 shows a possible program flowchart for the method according to the invention for generating suitable scan patterns;

FIG. 6 shows another variant of a program run for the method according to the invention for generating the objectively best scan mode;

FIG. 7 shows the available scan patterns for a 3×4 scan sorted into classes;

FIG. 8 shows the available scan patterns for a 3×3 scan sorted into classes; and

FIG. 9 shows a view of the results of the best scan pattern from FIG. 7 after the selection according to the flowchart shown in FIG. 6;

FIG. 10 shows the results of the best scan pattern from FIG. 8;

FIG. 11 shows a comparison of the resulting images using a 3×4 scan according to FIG. 3 and FIG. 9.

### DESCRIPTION OF THE PREFERRED EMBODIMENTS

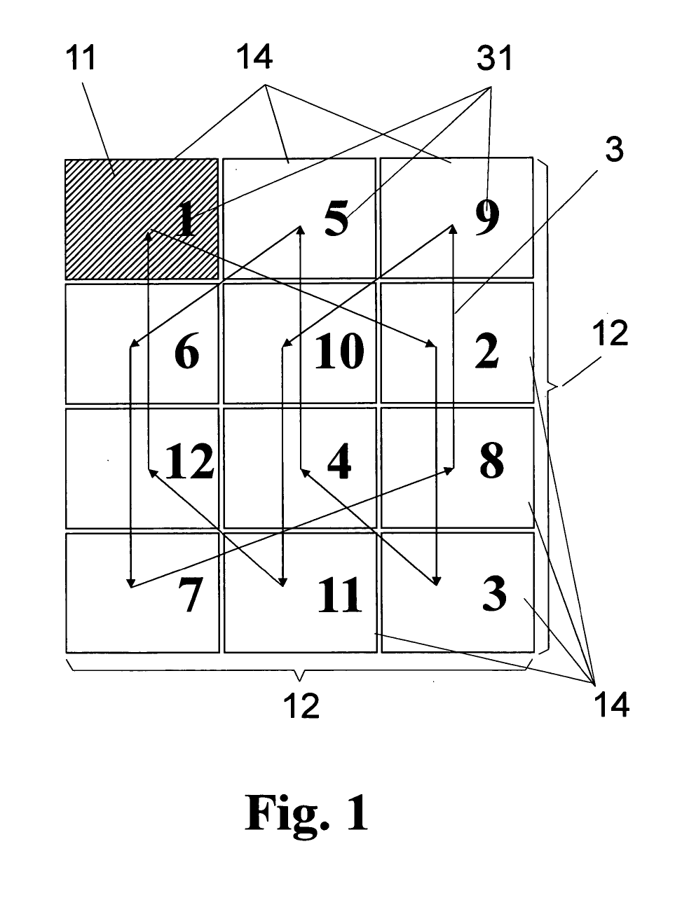

The arrangement according to the invention comprises an image sensor, wherein, by means of a scan mechanism (not shown) in a predetermined scan raster 12—shown schematically in FIG. 1 as a 3×4 scan raster—with a scan pattern 3 in which the goal of the resolution-increasing sensor movement is to prevent directly successive spatially adjacent scan positions 14 rather than pursue the shortest displacement path of the image sensor element 11. The scan positions 14 are represented in FIG. 1 by successive positions of a selected sensor element 11. The consecutive numbering of the scanning steps 13 over time is shown by scan numbers 31. It should be noted that the successive arrangement of scan positions 14 is used only for reasons of simplicity and that in reality there is often a spatial overlapping of the scan positions 14.

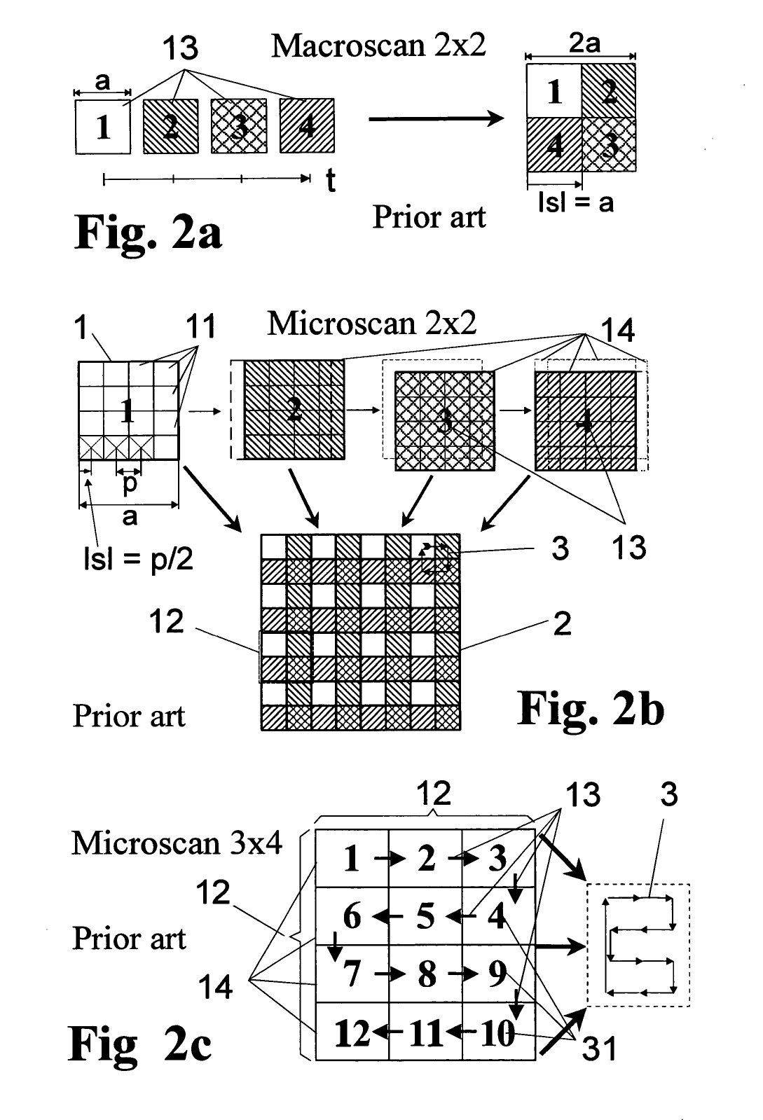

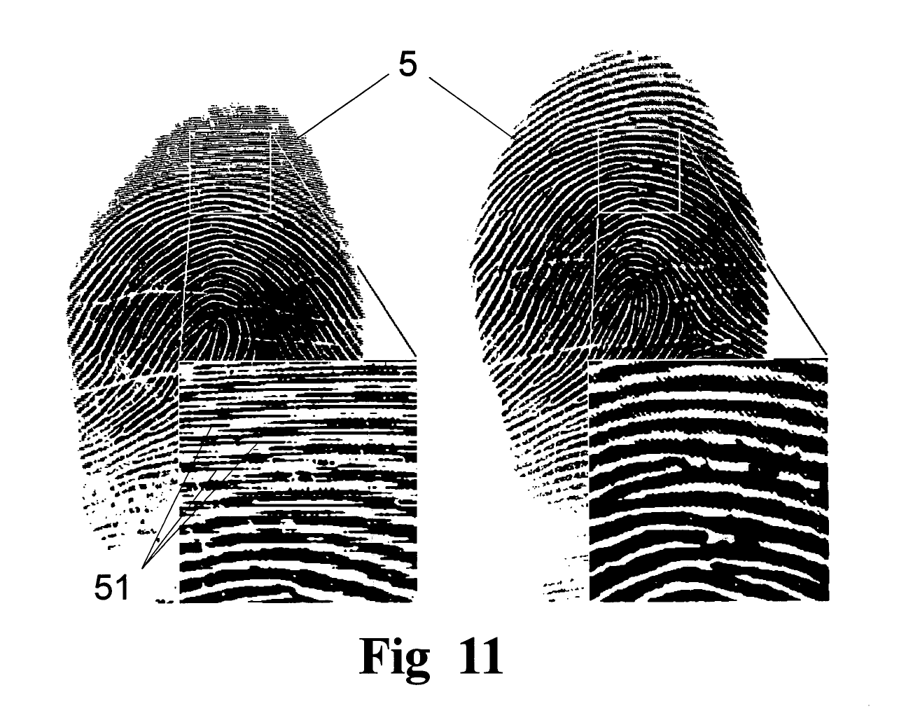

The suppression of artifacts 51 (shown only in FIG. 11) in the resulting image 2 (compare FIG. 2b) which is shown only for one sensor element 11 in FIG. 1 is most successful, according to the invention, when there is the most extensive possible equality of distribution of the time intervals (differences of the scan numbers 31) between the spatially adjacent scan positions 14. An optimized possibility of this kind for the scan pattern 3 is shown in FIG. 1 in continuous lines with arrows for a 3×4 scan raster 12.

In conventional recording of images with meander-shaped scanning mode—as is shown in different variants in FIGS. 2a to 2c—it has been shown that pronounced line-like structures occur (see at left in FIG. 11) when the recorded object (in this case, a fingerprint) moves minimally during the recording. These line-like artifacts 51 result when the individual resulting image points follow one another in time immediately in longitudinal direction of the meander-shaped scanning path (x-direction) and due to the long time intervals between the image points in the resulting image 2 in the advancing direction of the meander (y-direction).

The time interval between scan positions 14 is defined in FIG. 1 by the difference 32 of scan numbers 31 (consecutive numbers of a scanning step 13) from resulting image points of the sensor element 11 which are spatially adjacent in x-direction and y-direction. Assuming an image time of 100 milliseconds, for example, a complete resulting image has a maximum time interval of (n−1) 100 ms as the time interval between the first and last (nth) scan position.

The conventional scanning principle of image recorders with a macroscan will be illustrated first in FIG. 2a. The aim of the macroscan consists in that the image section scanned by the image sensor 1 is displaced stepwise over a much larger image surface of an object. The resulting image 2 which in this case is composed of a 2×2 macroscan is formed by the successive arrangement of the scanned image sections of the size of the entire image sensor 1 with edge length a. The quantity of the displacement path |s| between the positions of the image sensor 1 which can also be different for the two dimensions of the image sensor 1 is equal to an edge length a of the image sensor 1 in a different direction. Since this displacement process can easily be seen from the resulting image, only the time progression of the scan along time axis t is shown in the left-hand portion of FIG. 2a.

FIG. 2b shows the prior art for image scanning by means of a 2×2-format microscan. The image sensor 1 comprises, for example, 4×4 sensor elements 11 and is displaced by one half of a pixel spacing p/2. The resulting image 2 which is formed by the interlacing of the read-out signals has a fourfold increase in pixel density and therefore improved resolution as a result of the selected displacement path which is shown in the drawing as a scan pattern 3 for the fourth sensor element 11.

FIG. 2c shows the same subject matter as FIG. 2b, again as 3×4 microscan, for a better understanding of the structure of the scan pattern 3 according to the prior art. The individual scanning steps 13 are run through in order in the scan raster 12; in addition to the sequence of scan positions 14 which are moved to successively and whose time sequence is identified by the scan numbers 31, the path of the scanning steps 13 is shown separately in order to illustrate the scan pattern 3.

Additional considerations underlying the inventive idea will be set forth by way of example—without limiting generality—with reference to a 3×4 scan raster 12 (three positions in x-direction, four positions in y-direction).

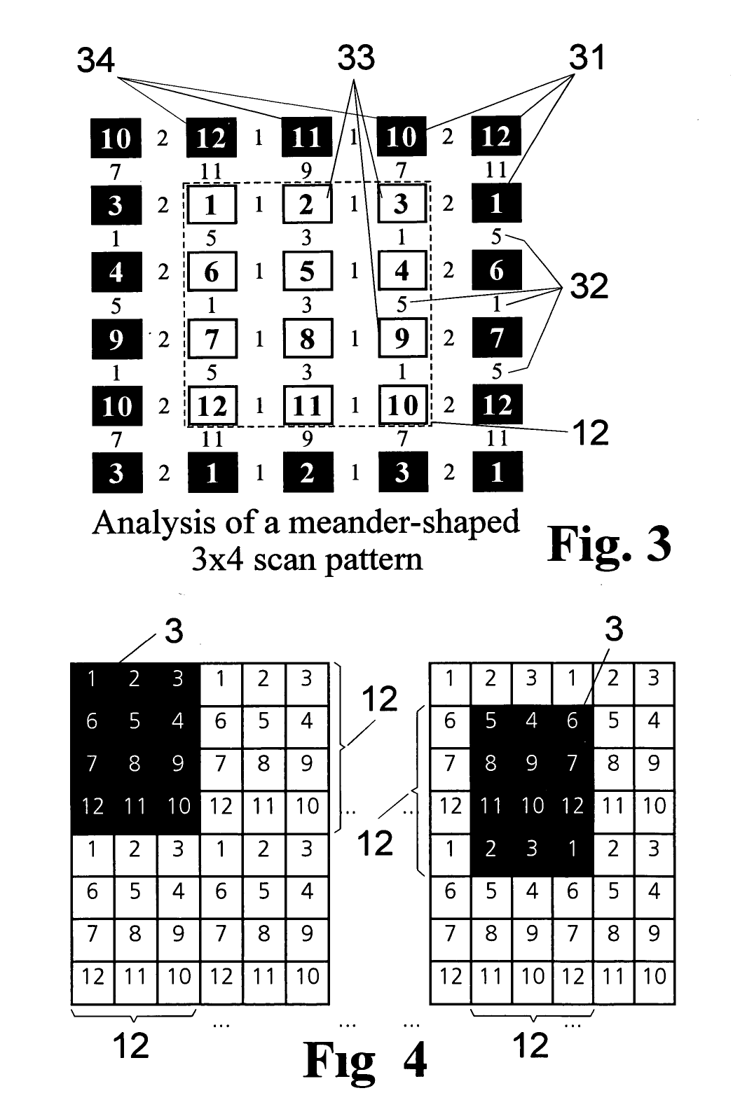

The time intervals between the scan positions 14 of a sensor element 11 in x-direction and y-direction are analyzed again in FIG. 3 for the meander-shaped 3×4 scan according to the prior art. The bordered white boxes represent the twelve different scan positions 33 for a selected sensor element 11 of the image sensor 1, wherein the indicated scan number 31 shows the consecutive number of the scanning steps 13 within a scanning cycle, i.e., the time sequence of the scan positions 14. The black boxes represent the scan positions 34 of adjacent sensor elements 11 which—due to the movement of the entire image sensor 1—must be moved in the identical meander-shaped pattern. The numbers between the boxes show the respective time interval between the adjacent scan positions 14, i.e., the difference 32 of the scan numbers 31, as quantity of scanning steps 13 executed therebetween. This time interval (difference 32) of the scanning steps 13 in the scanning cycle is regarded as a measurement for the susceptibility or sensitivity of the scan to a movement of the imaged object. The smaller this difference 32 is for many of the adjacent scan positions 14 then, by necessity, the higher the differences 32 must be at other places and the greater the probability that artifacts will be formed due to an (arbitrary) movement of the object. This is explained by the fact that double scanning of the same object point and faulty scanning of other object points due to object movement occur together within one scanning cycle.

Therefore, the following can be seen in FIG. 3 for a conventional meander-shaped 3×4 scan:

1. A very pronounced proximity in time of the scan positions in x-direction (shown as differences 32 having the value of one in x-direction, i.e., by a scanning step 13 between the scan positions 33 of the selected sensor element 11 in row direction); and

2. A maximum time interval (difference 32) of eleven scanning steps 13 in y-direction:

between the twelfth and the first scan position 33 of the selected sensor element 11;

between the first scan position 33 of the selected sensor element 11 and the twelfth scan position 34 of the next sensor element 11 upward; and

between the twelfth scan position 33 of the selected sensor element 11 and first scan position 34 of the next sensor element 11 downward.

This favors the formation of artifacts which manifest themselves as interference in the form of horizontal line structures (line-shaped artifacts 51 in FIG. 11). For this reason, the conventional ordered scanning in a meander-shaped scan pattern (shortest path of the image sensor 1 through all scan positions 14) is rejected and the goal is an approximately equal distribution of the time intervals between adjacent scan positions 14 in the scan pattern 12. For this purpose, a suitable scan pattern 3 which meets this requirement must be found. This is achieved in that all permutations of the scan positions 14 in the desired scan raster (e.g., 3×4 scan raster) are formed initially in order to acquire all possible scan patterns 3.

The designation (maximum, minimum) is used for classifying the scan patterns 3; the maximum 42 is the maximum time difference 32, and the minimum 41 is the minimum time difference 32, of all scan numbers 31 of spatially adjacent scan positions 33 of a selected sensor element 11, and the minimum of the differences 32 is used for sorting the scan pattern 3 into classes. Accordingly, the value (11,1) is given for the commonly used meander-shaped scan pattern 3 as can easily be seen in FIG. 3.

An algorithm by which all possible position sequences can be systematically calculated was developed for examining different scan patterns 3. It may be assumed for purposes of simplifying that the first scan position 14 with scan number “1” is always in the upper left-hand corner of the scan pattern 3. This is possible because a resulting image 2 must be understood as a direct combination of a plurality of adjacent scan patterns 3.

As can be seen from FIG. 4, referring to an example for the 3×4 scan raster which is scanned in a meander-shaped manner, a plurality of equivalent scan patterns 3 are possible (ignoring the image border) when ordered meander scanning is not prescribed. This is the approach of the invention, so that equivalence is ensured even when taking into account the interface conditions of the scan pattern 3 of a sensor element 11 relative to the adjoining identical scan patterns 3 of the neighboring sensor elements 11 of the image sensor 1. This consideration was taken as a basis in FIG. 3 for the analysis of the 3×4 scan according to the prior art in order to uncover the reasons for the artifacts 51.

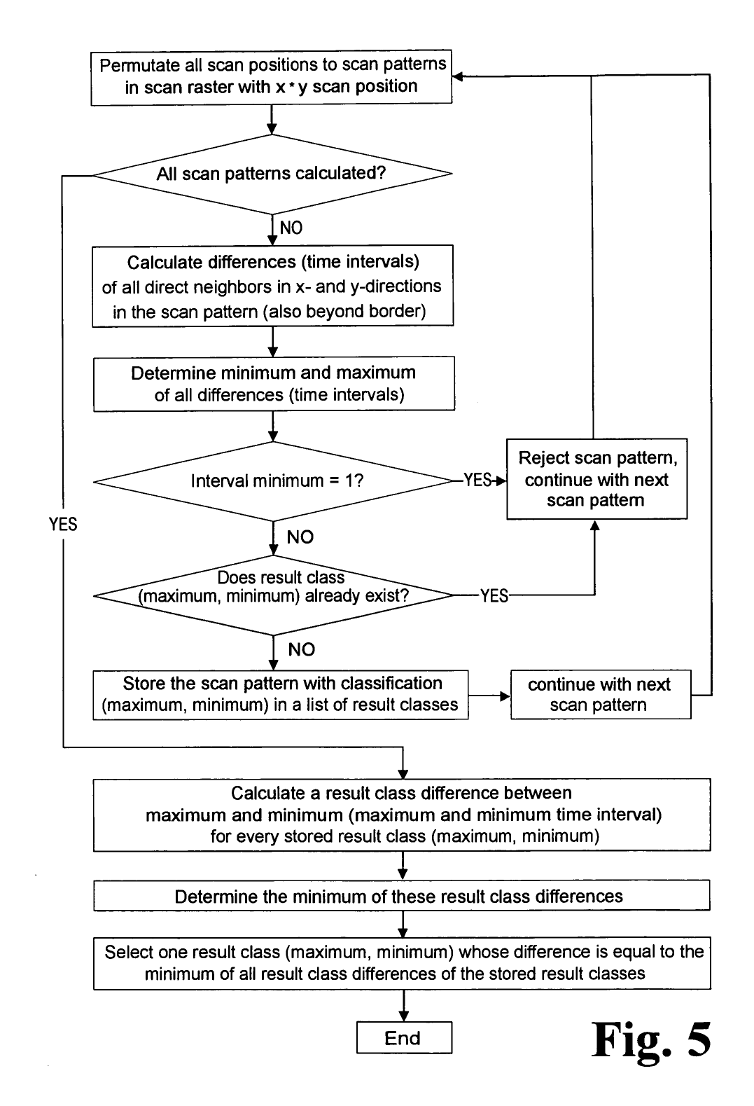

As is shown in FIG. 5, the algorithm for determining a scan pattern 3 according to the invention contains the following steps:

1. forming scan patterns 3 for a selected sensor element 11 of the image sensor 1 over all permutations of n×m scan positions 14 for a given scan raster 12, wherein the time sequence of the scan positions 14 is characterized by a scan number 31;

2. calculating all differences 32 of scan numbers 31 of adjacent scan positions 14 in x-direction and in y-direction of the scan raster 12 for every scan pattern 3;

3. determining the minimum 41 and maximum 42 of all differences 32 of scan numbers 31 for classifying every scan pattern 3;

4. eliminating all scan patterns 3 in which the minimum 41 of the differences 32 is equal to 1;

5. selecting the scan pattern 3 in which the maximum 42 and minimum 41 of the differences 32 of the scan numbers 31 lie as close to one another as possible as the suitable scanning mode.

On the one hand, the selection of suitable scan patterns 3 can be carried out by means of:

5.1 comparing the differences from the maximum 42 and minimum 41 of the classified scan patterns 3, wherein scan patterns 3 with the smallest difference from the maximum 42 and minimum 41 are selected as suitable.

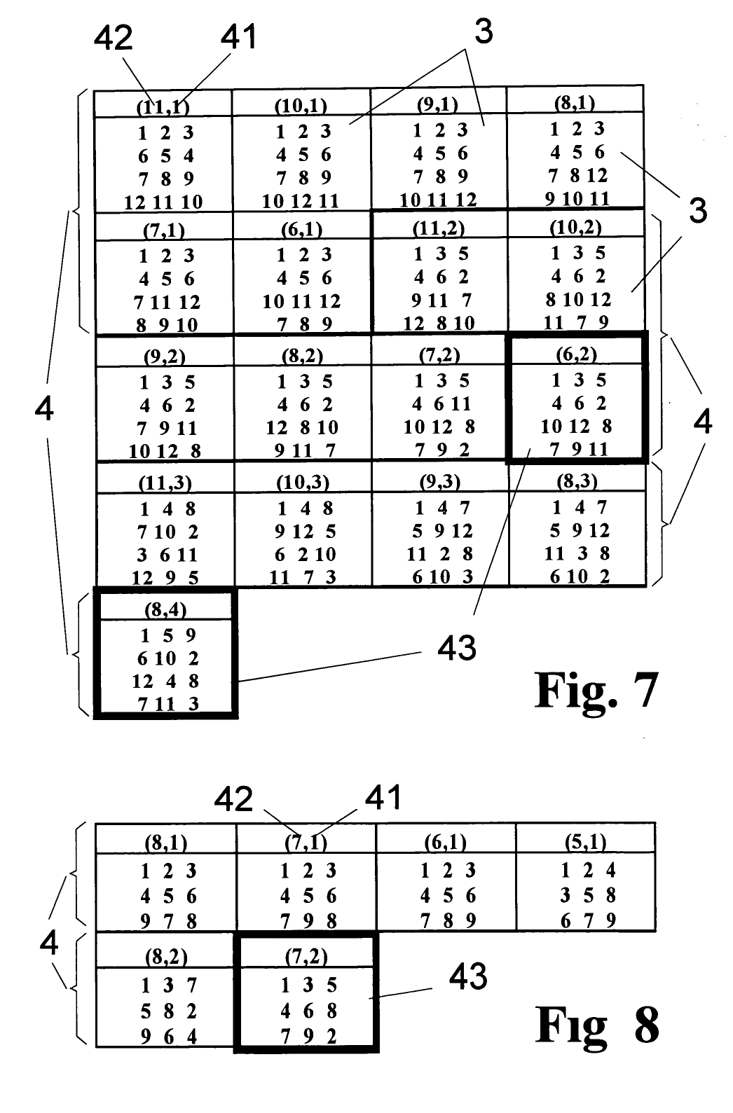

With the method according to FIG. 5, the classes 4 shown with thick borders in FIGS. 7 and 8 are determined as optimized scan patterns 43 for which the above-mentioned criteria are met using the instruction noted in 5.1.

On the other hand, the selection can be carried out as a stricter criterion by:

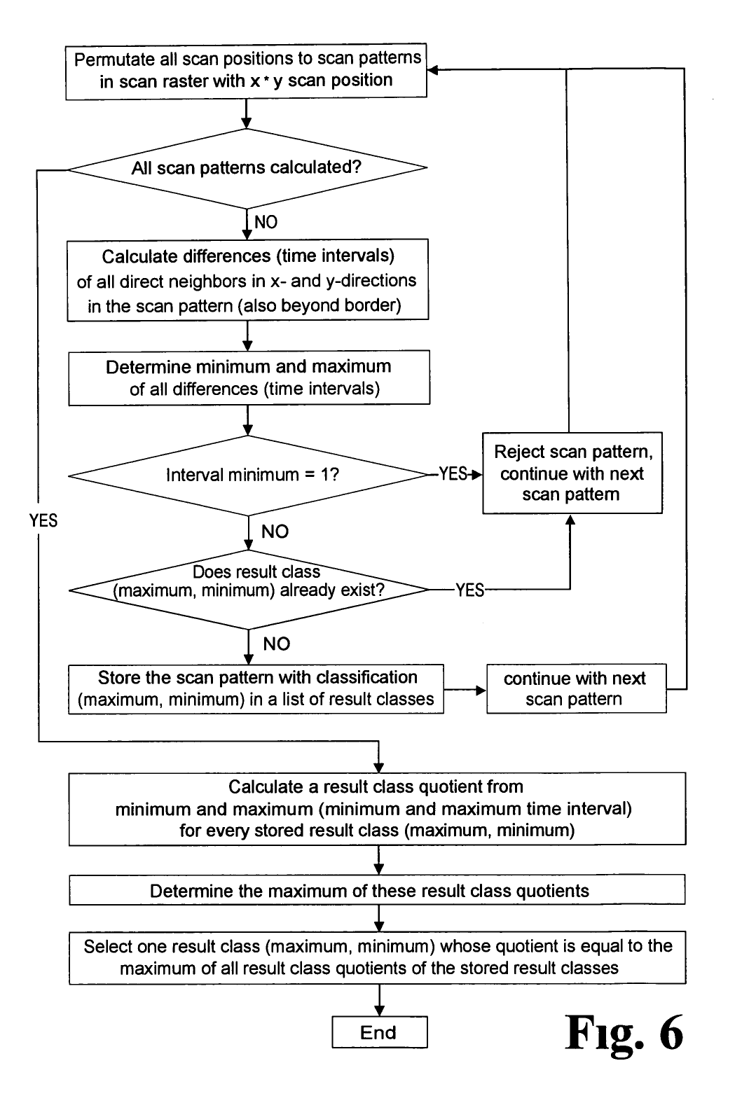

5.2 comparing the quotients from the minimum 41 and maximum 42 of the classified scan patterns 3, wherein the greatest quotient characterizes the most suitable scan pattern 3. FIG. 6 indicates the program run required for this purpose.

FIG. 7 shows the list of scan pattern classes according to the rules of the first to third steps of the algorithm for the 3×4 scan raster 12. The scan positions 33 of a selected sensor element 11 are numbered from 1 to 12. A scan pattern class 4 is characterized by the minimum difference 32 of the scan numbers 31 of adjacent scan positions 33 in the scan patterns 3 formed through permutations of the scan positions 33.

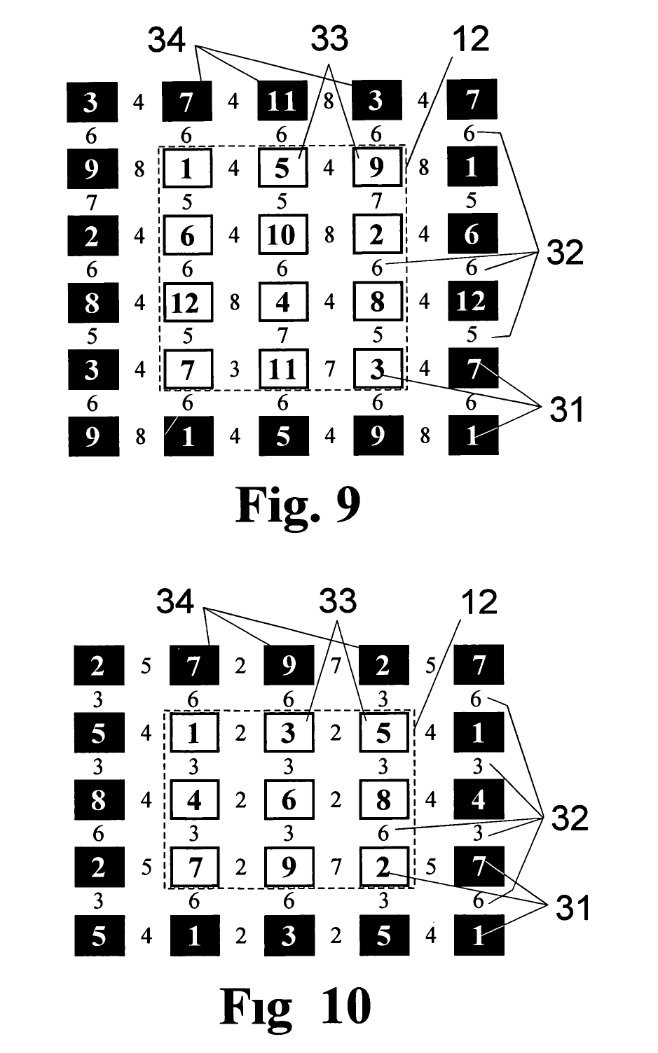

Class 4 of scan patterns 3 having the value of one as minimum 41 of the differences 32 is immediately rejected in step 4 of the process, so that directly adjacent scan positions 33 are ruled out (also in the transition to scan positions 34, compare FIG. 9). Six scan patterns 3 belong to this class 4 designated as (k, 1).

In the next class 4, in which the minimum 41 of the difference 32 of the scan numbers 32 is equal to two (designated (k, 2)), six scan patterns 3 are also indicated. The additional classes 4 designated (k, 3) and (k, 4) are represented by four and one scan patterns 3. The scan patterns (6, 2) and (8, 4) have the closest proximity of minimum and maximum of the scan number differences corresponding to the selection rule (step 5) mentioned above.

When a decision is made with difference criterion between maximum and minimum, both scan patterns (6, 2) and (8, 4) are equal and can be selected as desired for programming the scan mechanism of the image sensor 1.

In order to carry out the entire process for generating the suitable scan pattern 3 objectively and automatically, the ratios of minimum 41 to maximum 42 of every scan pattern 3 (compare FIG. 7) are formed as selection criterion for the best scan pattern 3, and the class 4 designated (8, 4) and the greatest quotient 4/8=1/2 are extracted relative to the designation (6, 2) 2/6=1/3 which appeared as equivalent in comparison to the differences from the maximum and minimum of the classification.

FIG. 8 shows scan pattern classes 4 for a 3×3 scan raster for purposes of further illustration. The scan positions 33 according to FIG. 10 are numbered 1 to 9 in this case. Only two classes 4 with four and two represented scan patterns 3 result as classification through the permutations of the sequence of scan positions 33; the first (k, 1) of these classes is rejected by reason of the fourth rule of the method indicated above. The remaining two scan patterns 3 of the second class 4 designated (k, 2) have classifications (8, 2) and (7, 2) and give the classification (7, 2) as optimized scan pattern 43 when each of the selection steps 5.1 or 5.2 is applied.

In FIG. 9, the scan pattern 43 which is optimized according to the invention for a 3×4 scan raster 12 is shown by characterization of scan positions 33 and 34 with scan numbers 31 and indication of the differences 32 (as time intervals) of the spatially adjacent scan positions 33 and 44. FIG. 9 is laid out schematically in the same way as FIG. 3 and represents a view equivalent to the scan pattern 3 according to the invention shown in FIG. 1. The clearly improved scanning quality of the scan pattern 3 of FIG. 9 compared to FIG. 3 (meander scan according to the prior art) can be seen from FIG. 11. In this case, the images of two recordings with a microscan in 3×4 scan raster in which the imaged finger has moved to a minimal extent have been acquired with the different scan patterns 3 (according to FIGS. 3 and 9). The recording on the left was made with meander-shaped scanning (in the flowchart shown in FIG. 7: using the scan pattern 3 with the class designation (11,1)) and shows clearly visible linear artifacts 51. The image on the right was made using the scan pattern 43 with classification (8, 4) from FIG. 7. It can be seen that the very pronounced false line structures or linear artifacts 51 of the imaged fingerprint 5 no longer occur with the method shown in the invention (as in the image at left in FIG. 11) and the method accordingly shows a distinctly improved behavior with respect to movements of the object.

Therefore, a considerable improvement in image recording devices which use a microscan for increasing resolution can be achieved by means of the invention with respect to susceptibility to image errors caused by slight movement of the object.

This is also true in principle for macroscan scanning, although the permissibility of an (unwanted) object movement is much more limited from the outset due to the large scanning paths (edge length a of the image sensor 1).

The method according to the invention can be applied relatively economically by reworking the driver software of a scanning image sensor 1 and by means of a one-time recalibration of the image recording with this new software for all previously known optically scanning image recorders. No limits are imposed on the use of the method according to the invention for generating a suitable scan pattern 3 by scan rasters 12 other than those indicated above. Therefore, an optimized scan pattern 43 which determines the nature and quality of the image recorder as a scanning configuration stored in the software can be found for any desired two-dimensional scan mode.

While the foregoing description and drawings represent the present invention, it will be obvious to those skilled in the art that various changes may be made therein without departing from the true spirit and scope of the invention.

Reference Numbers:

1 image sensor

11 sensor element

12 scan raster

13 scanning step

14 scan position

2 resulting image

3 scan pattern

31 scan number

32 difference of scan numbers

33 scan positions of a selected sensor element

34 scan positions of adjacent sensor elements

4 classes (of permutated scan positions)

41 minimum (of scan number differences)

42 maximum (of scan number differences)

43 optimized scan pattern

5 fingerprint

51 line-shaped artifacts

What is claimed is:

1. An arrangement for recording highly resolved two-dimensional images comprising:
a scanning mechanism for two-dimensional movement of the image sensor for a resolution-increasing multiplication of the scanned image points; and
a scan pattern for the sensor movement in a selected scan raster with n scan positions in x-direction and m scan positions in y-direction, which scan pattern has a fixed sequence of scan positions for each of the sensor elements, wherein there is a time interval of at least two scanning steps for spatially adjacent scan positions in x-direction and y-direction.

2. The arrangement according to claim 1, wherein the scan pattern for a given scan raster is optimized in such a way that the time intervals between respective spatially adjacent scan positions in the x-direction and y-direction in the entire scan pattern have a maximum and a minimum lying as close together as possible.

3. A method according to claim 1, including the step of using the scan pattern for a given n×m microscan, where n and m are the quantity of scan positions in the row direction and column direction of a given scan raster.

4. A method according to claim 1, including the step of using the scan pattern for a given n×m macroscan, where n and m are the quantity of scan positions in the row direction and column direction of a given scan raster.

5. The arrangement according to claim 1, wherein the scan pattern is integrated in the control software for the scan mechanism of the image sensor.

6. A method for generating an optimized scan pattern for two-dimensionally scanning image recording systems in which resolution is increased by movement of the image sensor in a determined scan raster and artifacts caused by movement are suppressed, comprising the following steps:
assigning all possible scan patterns for the image sensor over all permutations of n×m scan positions for a given scan raster, wherein the time sequence of the scan positions is characterized by a scan number as a consecutive number of the scanning step;
calculatng all differences of the scan numbers of adjacent scan positions for every scan pattern in x-direction and y-direction of the scan raster;
determining the minimum and maximum of all differences of scan numbers for the classification of every scan pattern;
eliminating all scan patterns in which the minimum of the differences is equal to one;
selecting the suitable scan pattern by a selection criterion in which the maximum and minimum of the differences of the scan numbers lie as close together as possible.

7. The method according to claim 6, comprising the step of carrying out the selection of the suitable scan pattern by comparing the differences of the maximum and minimum of every scan pattern, wherein the scan pattern with the smallest difference from the maximum and minimum of the scan number differences represents an optimum.

8. The method according to claim 6, comprising the step of carrying out the selection of the suitable scan pattern by comparing the quotients from the minimum and maximum of every scan pattern, wherein the scan pattern with the greatest ratio of minimum to maximum of the scan number differences is selected as optimum.
